(19) United States
(12) Patent Application Publication
(10) Pub. No.: US 2006/0221532 A1
(43) Pub. Date: Oct. 5, 2006

(54) Apparatus for protecting DC-powered equipment from power events occurring at the equipment power input

(75) Inventors: John E. Fuller, Rogersville, TN (US); Ernest Gallo, Florham Park, NJ (US); Chrysanthos Chrysanthou, Englewood, NJ (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/362,610

(22) Filed: Feb. 27, 2006

Related U.S. Application Data
(60) Provisional application No. 60/667,019, filed on Mar. 31, 2005.

(51) Int. Cl. H02H 9/06

(52) U.S. Cl. 361/118

(57) ABSTRACT

Apparatus provide protection for the power input of DC-powered equipment so that transients from a DC power supply do not cause equipment damage leading to spontaneous or eventual failure. The apparatus may include energy absorbing components that provide a closed or short circuit upon a voltage exceeding a threshold being output by the DC power supply, and the closed circuit directs energy away from the DC-powered equipment to prevent the excess voltage or energy from causing damage. The electrical pathway of the energy absorbing components may be unfused so that an alarmable fuse of the DC power supply may be blown by a sustained overcurrent condition and an alarm is triggered to indicate the occurrence of the DC power event. Additionally, the apparatus may be mounted to a rail near the protected equipment or may alternatively be strapped to nearby wiring.

### RELATED APPLCATIONS

This application claims the benefit of provisional application 60/667,019 filed on Mar. 31, 2005, and entitled DC Power Protector which is hereby incorporated by reference.

### TECHNICAL FIELD

The present invention is related to power protection. More particularly, the present invention is related to the protection of DC-powered equipment from power events.

### BACKGROUND

Electronic equipment is powered by a DC voltage, typically −48 Volts in the case of telecommunications DC-powered equipment. On one side, the DC-powered equipment has DC power inputs that receive the DC voltage from a DC power supply. On the other side, the DC-powered equipment has output connections. In the case of some DC-powered telecommunications equipment, such outputs may be connected to twisted pair lines that lead to customer premises to provide a telecommunications service to the customer.

At times, the DC power supply may generate unexpected surges or transients that result in the power supply voltage exceeding the expected amount for a brief period. In certain instances, these surges may be greater than the DC-powered equipment is capable of handling, and the DC-powered equipment fails as a result. Failed equipment results in downtime for the service to the customer, and the repair or replacement is costly.

Digital Subscriber Line Access Multiplexers (DSLAMs) are one example of such DC-powered telecommunications equipment. The DSLAM typically includes common cards and line cards installed within a chassis where a common shelf of the chassis receives the DC power supply input and distributes the power to the cards installed in the chassis. When a power event occurs at the DC power input that causes the voltage to exceed that which is expected, one or more of the DSLAM cards may fail, and DSL customers lose service until the DSLAM cards can be replaced.

### SUMMARY

Exemplary embodiments of the present invention address these issues and others by providing an apparatus that connects to the DC power supply voltage being provided to the DC power input of the DC powered equipment. When the DC power supply output exceeds the expected amount, energy absorbing components of the apparatus dissipate the energy to prevent it from reaching the electronic equipment. In certain embodiments the energy absorbing components may short circuit the DC power supply output to ground when a threshold voltage is reached. The electrical pathway of the apparatus may be unfused so that alarmable fuses of the DC power supply may operate to trigger an alarm if the current exceeds a prescribed amount. In certain embodiments, the apparatus may be rail mounted while in others it may be strapped to the wiring harness of the DC power supply or other nearby leads to save space on or within the chassis.

One embodiment is an apparatus for protecting DC-powered equipment. The apparatus includes a plurality of energy absorbing components where each energy absorbing component provides a substantially open circuit until exposed to a voltage that exceeds a threshold and then provides a closed circuit. At least one energy absorbing component is connected via an unfused electrical pathway between a positive DC power supply output and ground and in parallel with a positive DC power input of the DC-powered equipment. At least one energy absorbing component is connected via an unfused electrical pathway between a negative DC power supply output and ground and in parallel with a negative DC power input of the DC-powered equipment. Additionally, at least one energy absorbing component is connected via an unfused electrical pathway between the positive DC power input and the negative DC power input of the DC-powered equipment.

Another embodiment is an apparatus for protecting DC-powered equipment. The apparatus includes a plurality of energy absorbing components and a casing containing the plurality of energy absorbing components. Electrical conductors leading to the energy absorbing components extend out of the casing. The casing is strapped to a wiring harness from which leads of the DC power supply extend to interconnect with the electrical conductors and the DC power supply input of the DC-powered equipment.

Another embodiment is an apparatus for protecting DC-powered equipment. The embodiment includes a plurality of energy absorbing components where each energy absorbing component provides a substantially open circuit until exposed to a voltage that exceeds a threshold and then provide a closed circuit, the energy absorbing components receiving voltage via an unfused electrical pathway from a DC power supply output and in parallel with a DC power input of the DC-powered equipment, and wherein at least one of the energy absorbing components provides a pathway from a DC power supply output to the DC power return upon providing a closed circuit. The DC power supply comprises an alarmable fuse having a current threshold, and wherein upon the DC power supply providing a voltage that exceeds the threshold, at least one of the energy absorbing components provides the closed circuit from the DC power supply output, via powering or ground conductors, to the DC power return such that current is output from the DC power supply that exceeds the current and time threshold of the alarmable fuse causing the alarmable fuse to operate and trigger an alarm.

### DESCRIPTION OF THE DRAWINGS

FIG. 1 shows a view of the placement of the DC power supply, the protection apparatus, and the chassis where the DC-powered equipment is located according to one exemplary embodiment.

FIG. 2 shows a view of the apparatus and the interconnection of the energy absorbing components according to one exemplary embodiment.

FIG. 3 shows the apparatus mounted to a side equipment rail alongside the DC-powered equipment according to one exemplary embodiment.

FIG. 4 shows the apparatus strapped to a wiring harness for the leads of the DC power supply output that connect to the power supply input terminals of the common shelf according to one exemplary embodiment.

### DETAILED DESCRIPTION

Exemplary embodiments provide an apparatus that protects the DC power input of DC-powered equipment such as telecommunications equipment from DC events including transients output by a DC power supply. The apparatus includes energy absorbing components that prevent the transient DC event from reaching the DC-powered equipment.

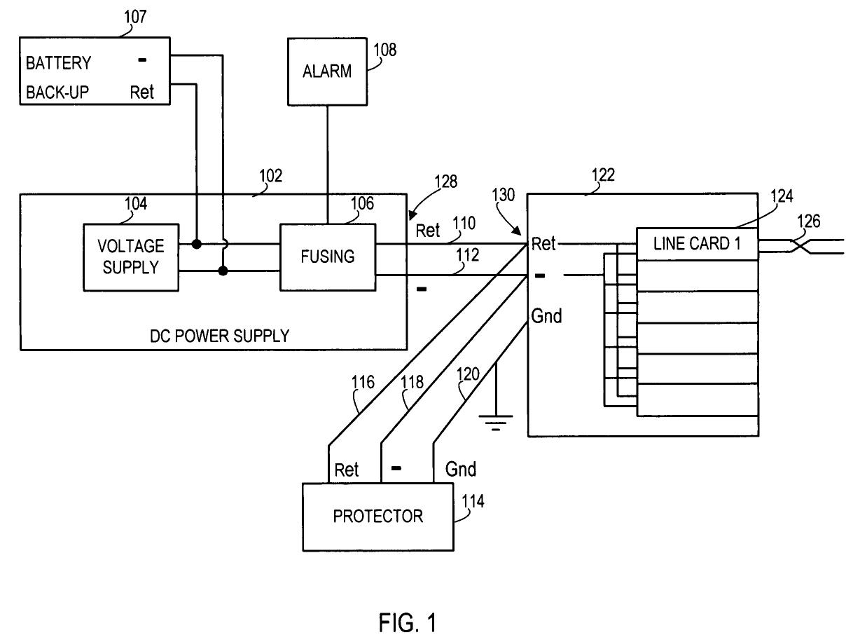

FIG. 1 shows an example of the exemplary configuration including the DC power supply 102, the chassis or rack 122, and the protector apparatus 114. The DC power supply 102 of this example includes a voltage supply 104 that outputs a substantially constant output voltage except that a transient may occur from time to time. The transient may occur due to various reasons, including variation in the voltage being supplied to the voltage supply 104, faulty power supply components, etc. A back-up battery 107 may also be included to provide power to the downstream equipment in situations where the source voltage for the power supply 104, such as the public utilities, fails.

The voltage supply 104 provides the voltage through fusing 106 to an output 128. The fusing 106 of this example is alarmable fusing that once an overcurrent condition exists for an adequate amount of time, the alarmable fusing operates, such as by becoming blown, to trigger an alarm 108. The alarm 108 may be audible, visible, remotely indicated, or a combination of these in order to indicate to personnel that a significant DC event that has exceeded the fusing threshold has occurred.

The voltage is provided to the DC-powered equipment via conductors 110 and 112 connected to first and second polarity terminals, namely a return terminal and a negative terminal in this example, of output 128. The conductors 110, 112 connect to a DC power input 130 of the chassis or rack 122. The chassis or rack 122 includes one or more circuit cards 124 that comprise the DC-powered equipment, such as a DSLAM. In this example, the line card 124 interfaces to a customer premises via twisted pair conductors 126. The line card 124 receives DC power from a distribution via the chassis or rack 122 from the DC power input 130.

The DC power input 130 of this example includes first and second polarity input terminals, namely return and negative terminals in this example, as well as frame ground terminals. The protector apparatus 114 includes conductors 116, 118, and 120 that form the electrical pathway between the DC power input 130 and the electrical components of the protector apparatus 114. Conductor 116 is connected to the return terminal, conductor 118 is connected to the negative terminal, and conductor 120 is connected to the frame ground conductor. Accordingly, in this example the protector apparatus 114 is connected in parallel with the DC power input 130 and the protector apparatus 114 provides protection by providing a short circuit in response to excess voltage or lifetime energy dissipation. By providing a short circuit, the ability of the alarmable fuse to trigger the alarm 108 is maintained. However, it will be appreciated that alternative configurations for other embodiments are also possible, such as where the protector apparatus 114 is connected in series between the DC power supply output 128 and the DC power input 130 and the protector apparatus 114 provides protection by having energy absorbing components and fusing that provide an open circuit in response to excess voltage.

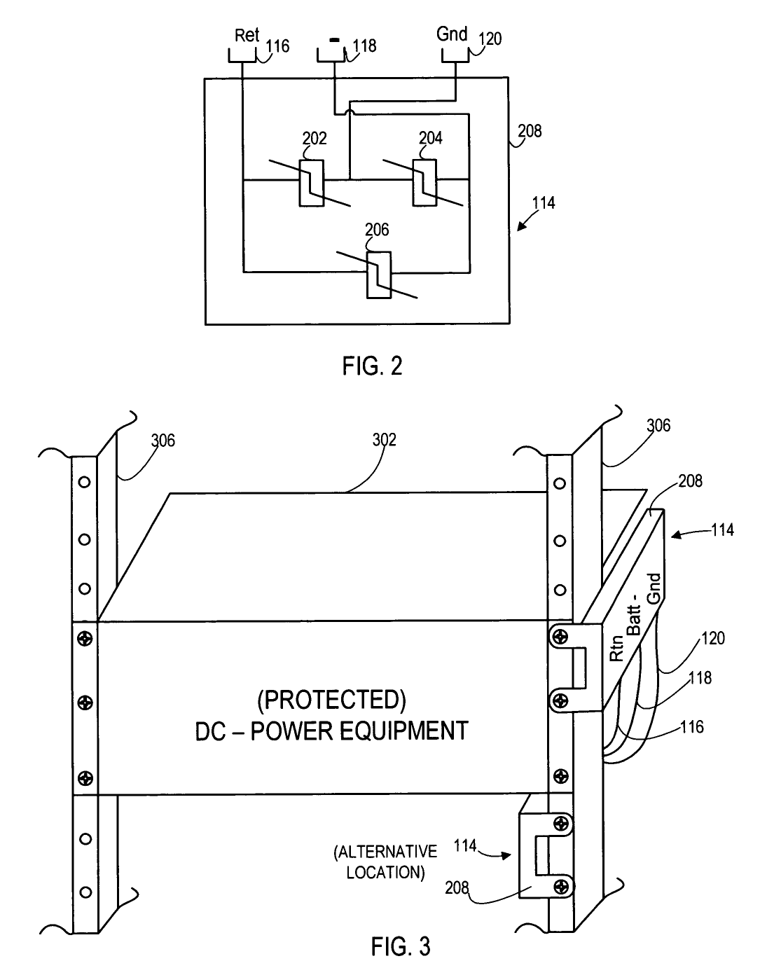

FIG. 2 shows the configuration of energy absorbing components in this example where the protector apparatus is in parallel with the DC power input 130. This embodiment includes a casing 208 that houses three energy-absorbing metal oxide varistor (MOV) segments, each comprised of one or more MOVs connected in parallel to meet energy dissipation requirements based on particular powering applications, items 202, 204, and 206. However, it will be appreciated that other energy absorbing/dissipating components may also be used, such as silicon avalanche diodes, zener diodes, resistors, or positive temperature coefficient devices. The casing 208 may be made of various materials in various combinations such as a metal structure, a high-temperature inert composite structure, epoxy or silica sand encapsulation. Regardless of the materials chosen, providing ventilation for the casing 208 improves safety by precluding high-energy fracture and may prolong the usable life of the energy absorbing components.

The MOVs 202, 204, 206 of this example are normally in a non-conductive state in that they are chosen so that their breakdown voltage is greater than the nominal or expected voltage of the output of the DC power supply 102. In the non-conductive state, the MOVs are substantially open circuits in that only a small leakage current will flow through them, but upon reaching the breakdown voltage, the MOVs become highly conductive to provide a current path to dissipate the excess voltage. For example, for a 48 Volts DC (VDC) nominal output for the DC power supply, the MOVs may be chosen to have a nominal breakdown voltage of 75 VDC. In that case, once the DC power supply 102 produces an output in excess of 75 VDC, one or more of the MOVs 202, 204, 206 begin to conduct to direct current from the power supply away from the DC-powered equipment and prevent the excess voltage and energy from causing damage.

As shown, one MOV 202 is positioned between the return conductor 116 and frame ground 120. Another MOV 204 is positioned between the negative conductor 118 and frame ground 120. In this example, an additional MOV 206 is positioned between the return conductor 116 and the negative conductor 118. Accordingly, if the excess voltage presents itself on the return terminal 116 relative to frame ground 120, on the negative terminal 118 relative to frame ground 120, or between the return and negative terminals 116 and 118, the corresponding MOV will begin conducting to protect the DC-powered equipment 124.

It should be noted that while FIG. 2 shows square corners for the wiring between the MOVs, it may be desirable to maintain the wiring in as straight and short a configuration as possible, with no sharp bends. It should further be noted that the ends of the conductors 116, 118, and 120 may include spade terminals to simplify the installation of the protector apparatus 114. Spade terminals allow the conductors 116, 118, and 120 to be easily connected to screw-type terminals that may be present for the DC power input 130 of the rack or chassis. In the example of a 48 VDC power supply with 75 VDC MOVs, it may be desirable for the conductors 116, 118, and 120 to be AWG 14-12 insulated leads and have a length of about one foot.

FIG. 3 shows rack mounting configurations for an example of the protector apparatus 114. In this example, the casing 208 is an equipment side-rail-mount version that may be mounted to the equipment side rail 306 of an equipment rack 304 (inside or outside the rack as shown), near the protected equipment chassis 302. The conductors 116, 118, and 120 extend to the location of the DC power input where the spade terminals are used to interconnect the conductors 116, 118, and 120 to the proper terminals of the DC power input.

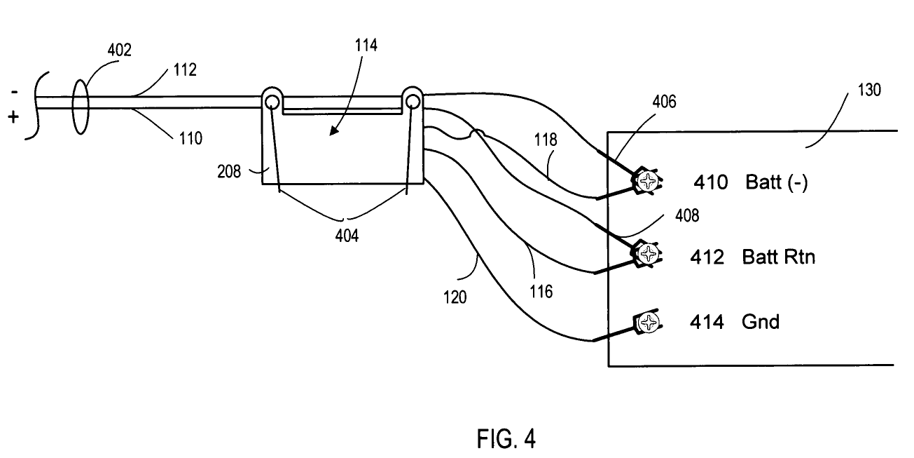

FIG. 4 shows another mounting configuration for an example of the protector apparatus 114. In this example, the casing 208 may be strapped to nearby wiring, such as wiring harness 402 that interconnects the conductors 110, 112 of the DC power supply 102 to the DC power input 130 of the equipment chassis. The casing 208 is affixed to the wiring harness 402 by straps 404. The straps 404 may be single-use wire-ties or a similar strapping mechanism. In some applications it may be desirable for the straps 404 to be releasable so that the protector apparatus 114 can be removed and reinstalled easily. The conductors 116, 118, and 120 extend to the respective terminals 412, 410, and 414 of the DC power input 130. The return terminal 412 and negative terminal 410 of the DC power input 130 also receive the spade terminals 408, 406 respectively of the wiring harness 402. By affixing the protector apparatus 114 to the wiring harness 402, equipment rack space or clearance is not required.

While the invention has been particularly shown and described with reference to various embodiments thereof, it will be understood by those skilled in the art that various other changes in the form and details may be made therein without departing from the spirit and scope of the invention.

What is claimed is:

1. An apparatus for protecting DC-powered equipment, comprising:
a plurality of energy absorbing components where each energy absorbing component provides a substantially open circuit until exposed to a voltage that exceeds a threshold and then provide a closed circuit,
wherein at least one energy absorbing component is connected via an unfused electrical pathway between a first polarity DC power supply output and ground and in parallel with a first polarity DC power input of the DC-powered equipment,
wherein at least one energy absorbing component is connected via an unfused electrical pathway between a second polarity DC power supply output and ground and in parallel with a second polarity DC power input of the DC-powered equipment, and
wherein at least one energy absorbing component is connected via an unfused electrical pathway between the first polarity DC power input and the second polarity DC power input of the DC-powered equipment.

2. The apparatus of claim 1, wherein the DC power supply comprises an alarmable fuse having a current threshold, and wherein upon the DC power supply providing a voltage that exceeds the threshold, the at least one of the energy absorbing components provides a closed circuit such that current is output from the DC power supply such that when the current output from the DC power supply exceeds the current and time threshold of the fuse, the alarmable fuse operates to trigger an alarm.

3. The apparatus of claim 1, wherein the energy absorbing components are metal oxide varistors.

4. The apparatus of claim 1, further comprising a casing containing the plurality of energy absorbing components, and wherein the unfused electrical pathway includes electrical conductors extending out of the casing.

5. The apparatus of claim 4, wherein the casing is metal.

6. The apparatus of claim 4, wherein the casing is epoxy.

7. The apparatus of claim 4, wherein the casing is mounted to a side of a chassis rack.

8. The apparatus of claim 4, wherein the casing is strapped to a nearby wiring harness.

9. An apparatus for protecting DC-powered equipment, comprising:
a plurality of energy absorbing components; and
a casing containing the plurality of energy absorbing components, wherein electrical conductors extend out of the casing, and wherein the casing is strapped to nearby wiring.

10. The apparatus of claim 9, wherein at least one energy absorbing component is connected via an unfused electrical pathway between a return DC power supply output and ground and in parallel with a return DC power input of the DC-powered equipment,
wherein at least one energy absorbing component is connected via an unfused electrical pathway between a negative DC power supply output and ground and in parallel with a negative DC power input of the DC-powered equipment, and
wherein at least one energy absorbing component is connected via an unfused electrical pathway between the return DC power input and the negative DC power input of the DC-powered equipment.

11. The apparatus of claim 9, wherein the DC power supply comprises an alarmable fuse having a current threshold, and wherein upon the DC power supply providing a voltage that exceeds the threshold, at least one of the energy absorbing components provides a closed circuit such that current is output from the DC power supply and such that when the current from the DC power supply exceeds the current threshold of the alarmable fuse due to excess surge energy or end-of-life protection device failure, the alarmable fuse operates to trigger an alarm.

12. The apparatus of claim 9, wherein the energy absorbing components are metal oxide varistors.

13. The apparatus of claim 9, wherein the casing is metal.

14. The apparatus of claim 9, wherein the nearby wiring comprises leads of the DC power supply nearby the input of the protected equipment.

15. An apparatus for protecting DC-powered equipment, comprising:
a plurality of energy absorbing components where each energy absorbing component provides a substantially open circuit until exposed to a voltage that exceeds a threshold and then provide a closed circuit, the energy absorbing components receiving current via a locally unfused electrical pathway from a DC power supply output and in parallel with a DC power input of the DC-powered equipment, and wherein at least one of the energy absorbing components provides a pathway from the DC power supply output to the power supply return upon providing a closed circuit, and
wherein the DC power supply comprises an alarmable fuse having a current threshold, and wherein upon the DC power supply providing a voltage that exceeds the threshold for a sufficient duration, at least one of the energy absorbing components provides a closed circuit from the DC power supply output to the power supply return such that current is output from the DC power supply that exceeds the current and time threshold of the alarmable fuse causing the alarmable fuse to operate and trigger an alarm.

16. The apparatus of claim 15, wherein the energy absorbing components are metal oxide varistors.

17. The apparatus of claim 15, further comprising a casing containing the plurality of energy absorbing components and interconnecting electrical conductors, and wherein the unfused electrical pathway includes electrical conductors extending out of the casing.

18. The apparatus of claim 17, wherein the casing is metal.

19. The apparatus of claim 17, wherein the casing is mounted to a side of a rack.

20. The apparatus of claim 17, wherein the casing is strapped to a wiring harness from which the electrical conductors extend from the casing to interconnect with the DC power supply leads at the input of the DC-powered equipment.
